(19) United States
(12) Patent Application Publication
(10) Pub. No.: US 2010/0181256 A1
(43) Pub. Date: Jul. 22, 2010

(54) USE OF A THREE-DIMENSIONAL FIBER SYSTEM

(76) Inventor: Detlef Militz, Hoppegarten (DE)

Correspondence Address: PAI PATENT & TRADEMARK LAW FIRM, 1001 FOURTH AVENUE, SUITE 3200, SEATTLE, WA, 98154, US

(21) Appl. No.: 12/664,388

(22) PCT Filed: Jun. 12, 2008
(86) PCT No.: PCT/EP2008/057440

§ 371 Date: Dec. 11, 2009

(30) Foreign Application Priority Data
Jun. 12, 2007 (DE) 102007027634.8

(51) Int. Cl. B01J 47/12

(52) U.S. Cl. 210/679

(57) ABSTRACT

The present invention relates to a use of a three-dimensional fiber system produced by textile manufacturing for anti-microbial treatment of process liquid in a process liquid system, wherein the fiber system has at least one first sheet-like structure and a plurality of spacer fiber elements extend transversely to the sheet-like structure in such a manner that the fiber system forms an elastically deformable three-dimensional spacer structure and a fiber having oligodynamic metal fractions is arranged in the sheet-like structure and/or in the region of the spacer fiber elements.

The present invention relates to the use of a three-dimensional fiber system produced by textile manufacturing.

Nowadays, a plurality of liquids is in use in technical plants and apparatuses of industry and trade. In such plants and apparatuses, these technical liquids or “process liquids” fulfill one or more functions, for example, as cooling agent, lubricant, transport agent, hydraulic switching and controlling agent or as consumable agent in procedural processes.

In the basic idea of the present invention, all media offering virtually no resistance to a change of their form and a relatively high resistance to a change of their volume are considered to be “liquids”. This definition comprises emulsions and suspensions.

An industrially very important process liquid is cooling liquid. In Germany, already about 27 billions cubic meter of cooling water are drawn off from power stations having predominantly a continuous flow cooling. Five billions cubic meter of cooling water from industrial refrigeration plants add thereto, wherein around 380 millions cubic meter come from plants having an open circuit cooling. For the same cooling efficiency, the water consumption in an open circuit cooling is merely about two to five percent of the need for the continuous flow cooling. However, the cooling water has to be usually conditioned with additives like biocides, hardness stabilizing agents, dispersants and/or anti-corrosive agents to prevent system malfunctions by deposition (scaling), corrosion and biomass growth (fouling). On the one hand, these additives are a significant environmental stress in regard to their waste disposal. On the other hand, these substances can act harmfully to one's health after the discharge into the atmosphere, if they are inhaled, for example. Also, compared with it, serious disadvantages exist, if corrosion and biomass growth occur excessively. The costs for the maintenance of the industrial plants and apparatuses increase, and, however, there exists a health risk for human, if microorganisms emerging from biomass growth come into the atmosphere and are assimilated from human by the respiratory organs, for example.

Further process liquids of industrially very high importance are so-called cooling lubricants. One differentiates
water-immiscible mineral oils with or without chemically acting admixtures. The mineral oils are used, if a good lubricating effect is needed above all.
Cooling emulsions as milky-white mineral oil containing oil-in-water-emulsions. Often, they are also referred to as cutting oil. These emulsions distinguish by good heat dissipation, the lubricating effect being rather low.
Mineral oil-free solutions being nearly transparent and containing soda ash or sodium nitrites in water. The properties correspond to those of the emulsion.

Such cooling lubricants contain a large number of additives, especially biocidal acting preservatives. The use of biocides is under observation pressure in connection with the EU biocide regulation 98/8/EG. This leads to considerable extra effort and extra costs for the producer and user of cooling lubricants. Therefore, there is need for alternative methods for preservation of cooling lubricants in this context.

A similar problem of the use of biocides in cooling lubricants exists in some hydraulic switching and controlling systems. Often, it can not be avoided that matter serving as nutrient medium for biomass growth is introduced in the process liquid being here a liquid switching medium, for example, water. To be able to prevent this growth, biocides have to be used again, leading to the already mentioned disadvantages. Another procedure is to remove the water from the microbially burdened switching and controlling systems in regular intervals and to purify these systems from biomass grown up, for example, in the form of biofilms. However, this leads to disadvantageous maintenance and stoppage times of the industrial plants having such hydraulic switching and controlling systems.

Therefore, the object of the present invention is to provide an easy, low-cost and hygienically harmless variant for the antimicrobial treatment of a process liquid.

This object is achieved by a use having the features of claim 1.

According to the invention, there is provided a treatment of a process liquid in a process liquid system with a three-dimensional fiber system produced by textile manufacturing, wherein the fiber system has at least one first sheet-like structure and a plurality of spacer fiber elements extend transversely to the sheet-like structure in such a manner that the fiber system forms an elastically deformable three-dimensional spacer structure, wherein a fiber having oligodynamic metal fractions is arranged in the sheet-like structure and/or in the region of the spacer fiber elements.

The below-explained construction and several variants of such three-dimensional fiber systems produced by textile manufacturing are known from WO2006/034701 A1.

In the basic idea of the present invention, all yarns and twines are considered as “fiber”. Especially, the twine construction enables to combine and further process by textile manufacturing fibers of different functionality in an easy manner together. Therefore, a twine having a copper containing fiber and a silver containing fiber is especially a variant preferred for some uses in order to use the range of the microbial efficacy of this two elements being broad in the combination.

The production of the three-dimensional fiber system by textile manufacturing ensures a high cost effectiveness and at the same time very flexible design possibilities for the fiber system. A production by textile manufacturing includes all known methods performed in textile machines, thus single or in combination, especially knitting, meshing, weaving, embroidering, knotting, etc. These processing techniques allow a very high degree of freedom in regard to the construction and the mechanical properties of the three-dimensional fiber system. So, the spacing of adjacent fiber portions and the mechanical integration thereof into the entire fiber system can be varied in a very broad range, for example. Thereby, the fiber system can be adapted in the best possible manner to the surrounding situation of the process liquid in the process liquid system. Especially, this concerns the adaptation to the provided installation space and/or to flow ratios of the process liquid.

The oligodynamically active metal of the at least one fiber confers to the fiber system an oligodynamic germicidal activity which is ensured on the one hand by the release of metal atoms and/or metal ions into the process liquid surrounding the fiber system and on the other hand by a contact reaction of microorganisms at the surface of the adequately equipped fiber. That is, besides the effect of the metal ions released into the water, the metal atoms or metal ions, respectively, not going into solution, being present at the fiber surface contribute—by using heavily soluble metal salts—to the entire oligodynamic effect of the fiber system to the process liquid.

Preferably, the fiber system contacts the process liquid at least in portions. Thereby, the oligodynamic effect of the fiber system can develop in immediate interaction with the process liquid. However, it is also possible by principle that one uses a transfer medium for transferring metal ions from the fiber system to the process liquid. But, this transfer medium being preferably a liquid is therefore again also a process liquid in the basic idea of the present invention.

In a preferred variant, the use is used, if the process liquid acts as a cooling liquid. Then, the process liquid is usually provided as cooling water in a cooling system in an industrial or commercial plant, respectively. As already mentioned in the introduction of the specification, the amount of cooling water being used in such systems yearly is so high that the consequences by disposal engineering and process engineering being related thereto are economically of high importance. Especially, the biomass growth in the cooling water can be reduced or completely prevented by using the fiber system, respectively.

The use in a cooling system designed in portions in an open manner to a surrounding atmosphere in such a way that the surrounding atmosphere contacts the cooling water is of special advantage. On the one hand, the contact with the atmosphere results in entering material in the cooling water from outside, wherein this material often serves as an “alimental basis” for the biomass growth. For this reason, such cooling systems are very susceptible to the occurrence of biomass growth. On the other hand, there is also the risk that especially in case of a high infestation of the cooling water by microorganisms, the microorganisms escape to the surrounding atmosphere, are assimilated there by human and lead to a disease, partially with resulting in death. This can take place by inhaling contaminated water in form of fine water droplets, for example. Often, such situations occur near power stations or air conditioners provided with an open cooling water circuit in such a manner that cooling water is ejected at least partially to the surrounding atmosphere.

Furthermore, the use in cooling systems of industrial or commercial plants being at least partially open towards the atmosphere has advantages. The biomass growth is inhibited or prevented and, therefore, at least due to this reason, a maintenance or disinfection, respectively, of the cooling system is not necessary any more. As examples for industrial and commercial plants, there are mentioned at this point plants contacting cellulose containing materials. The same is true for materials having natural fibers like cotton, linen, wool, etc. Even low amounts of these materials are an aliment for high amounts of microorganisms in wet surroundings. However, the entry of aliment for microorganisms can also occur essentially from the outside. Also, biological material coming from operating staff in form of danders, hairs, perspiration, etc. is a suitable aliment for many microorganisms.

Also, in a power station, in an air conditioner or in an industrial or commercial plant having a closed cooling water circuit, the fiber system can be used advantageously. Also, in closed cooling water circuits there can not be actually prevented to enter microorganisms during filling with water. Moreover, the systems are often not perfectly closed to the surroundings so that microorganisms and nutrients thereof can reach the circuit due to technical reasons or during maintenance works. In such a case, the treatment ensures that the biomass growth is and remains reduced or completely prevented, respectively.

In a further embodiment, the use provides that the process liquid in the form of a cooling lubricating liquid acts additionally as lubricating liquid. Here, the lubricating function adds to the cooling function. Such cooling lubricants being usually used as liquid have already been characterized in the introduction of the specification. Usually, cooling lubricating liquids are used in industrial and commercial plants working metals by intervention on the substance, for example, by turning, milling or drilling.

The use is especially advantageous, if the cooling lubricating liquid is employed as water-oil-emulsion in a cooling lubricating liquid system. Thereby, the cooling lubricating liquid remains microbiologically stable without the need of usual biocides so far, particularly on basis of formaldehyde. This leads to lower health stress of the operating staff and lower costs by the higher service life.

A further preferred variant of the use provides that the process liquid is used as hydraulic medium in a hydraulic switching or controlling circuit of an industrial or commercial plant. Also, according to the designs of the cooling circuits, biomass growth is often a problem in hydraulic circuits. Especially, this applies for circuits having regions through which material which is suitable as food for a lot of microorganisms comes regularly into the hydraulic medium. For example, this applies for plants contacting cellulose containing materials. Also, this applies for materials having natural fibers like cotton, linen, wool, etc. Thus, the method is especially advantageously employable, when the industrial or commercial plant is designed as paper producing and/or processing plant or as plant for producing and/or processing textiles.

A further preferred use provides that the process liquid is treated in a washing apparatus for laundry as remained laundry rinsing water. In this way, it is possible to store the remained laundry rinsing water in a reservoir without risking that this water becomes unsuitable due to microbial activity in the long run. Especially, this is true, for example, if substances being a good nutrimental basis for microorganisms are washed out, while rinsing the laundry. Especially, that is the case, when washing natural fiber textiles. Thus, it is particular advantageous that the treated laundry rinsing water will be employed as washing water for a newly starting washing step of the washing apparatus. By the fact that, f. e., the rinsing water of the last rinsing procedure in washing machines is stored for the use as first washing water in a new washing step, a further reduction of the water consumption of washing machines can be realized in an easy manner. This effect can be adopted to further washing apparatuses and washing processes for distinct laundries.

A further preferred embodiment of the use provides that the process liquid is treated as water containing liquid in a medical technical device or for a medical technical device. The water containing liquid can have one or more of the above described functionalities, for example, cooling and/or lubricating. Alternatively or additionally, there can be made provision to use the water containing liquid as industrial water in the medical technical device. For all this applications, it is regularly required to ensure high standards in regard to a permanent sterility of the water containing liquid and a piping system coming in contact therewith. This can be ensured in an easy manner by using a three-dimensional fiber system having oligodynamic activity.

A further embodiment of the use provides for the advantage that the process liquid is treated as filling water of a swimming pool or a whirlpool. Especially, the undesired infestation of algae occurring in the outside section can be prevented strongly and easily here.

In a further advantageous embodiment of the use, process liquid is used as ballast water in a ship. In this manner, the problematical carrying of (micro)organisms between very different ecosystems can be avoided.

It goes without saying that all above described variants of the use of a three-dimensional fiber system comprise also corresponding treatment methods.

The below explanations regarding the textile construction of the three-dimensional fiber system apply to all above described embodiments and in all associated combination possibilities of the features thereof.

The fiber system has a first sheet-like structure and a plurality of spacer fiber elements extend transversely to the sheet-like structure in such a manner that the fiber system forms an elastically deformable three-dimensional spacer structure, wherein the fiber having germicidal activity is arranged in the sheet-like structure and/or in the region of the spacer fiber elements.

The feature “transversely” with respect to the sheet-like structure comprises all angular positions between the sheet-like structure and the spacer fiber elements in the entire range between 0° and 180°. Moreover, it goes without saying that the spacer fiber elements do not necessarily run in a straight line, but may also be curved and intertwined. Furthermore, it is unimportant if the spacer fiber elements run transversely, within the meaning of the above definition, only in portions and other portions are arranged in the plane of the sheet-like structure.

On the one hand, it is conceivable that sheet-like structures and spacer fiber elements are formed from one and the same fiber. This variant can be produced by a suitable continuous method. It is likewise possible to produce the spacer fiber elements from a fiber other than the fiber forming the sheet-like structure.

Within the scope of the invention, therefore, there is provision, on the one hand, for forming the fiber system solely from the fiber having germicidal activity or also, on the other hand, as combination of at least one fiber of germicidal activity with at least one fiber without germicidal activity. In this case, the respective fibers are arranged in the sheet-like structure and/or in the region of the spacer fiber elements which lies adjacently to this or the sheet-like structure and/or the spacer fiber elements are formed at least partially from the respective fibers. A fiber is understood to mean any yarn or any twine. In case of the variant of the twine, a combination of oligodynamically active metals can be provided by means of several fibers. Thus, a twine combining a silver containing fiber with a copper containing fiber especially lends itself.

Spacer fiber elements are understood here to mean, in the simplest instance, fiber portions which have the necessary elasticity so that the fiber system has the desired properties.

Alternatively, it is likewise conceivable that the spacer fiber element also forms a specific spacer fiber system. That is, the spacer fiber element is itself constructed as a knitted fabric, woven fabric, knitted yarns, contexture or interlacing element comprising at least one fiber.

Of course, the fiber system also comprises the design variants which consist of a plurality of fibers. Spacer fiber elements oriented transversely with respect to the sheet-like structure form a three-dimensional spacer structure of the fiber system.

The feature of elastic deformability is to be understood here as meaning that the fiber system has a marked compressibility in relation to its dimensions transversely and, in particular, perpendicularly to the sheet-like structure. After deformation due to the action of force, the fiber system endeavors, on account of the material properties of the deformed spacer fiber elements, largely to assume the undeformed state again.

The elasticity properties described make it possible to use one and the same fiber system in a multiplicity of different process liquid systems. A volume unit of the fiber system which is greater than the space volume present in the mounting region of the process liquid system is introduced in compressed manner into the mounting region. The fiber system can be expanded there, and it clamps itself with the sheet-like structure and the spacer fiber portions onto the wall portions of the process liquid system which delimit the space volume.

Especially, the stagnation regions, especially at risk, can be equipped along their entire length of extent with the fiber system in this manner.

In this case, it is advantageous, in particular, that the fiber system is pressed against the wall portions of the stagnation regions on account of its elasticity properties. Thus, the fiber system comes into direct contact via its sheet-like structure and/or its spacer fiber elements with the critical biofilms occurring particularly here.

Moreover, the fiber system can easily be made for different sizes. For this purpose, a plurality of fiber systems can be connected to one another to form a coupled fiber system. This takes place, for example, by stitching, adhesive bonding, welding or hooking together of the individual fiber systems. The functionality of the coupled fiber system then still always corresponds to that of the individual fiber systems.

It goes without saying that the entire fiber system must have, in particular, the required elasticity properties over the entire temperature range of the process liquid. The materials used are selected accordingly.

Oligodynamic metals are known to the relevant person skilled in the art here. They are semiprecious and precious metals such as gold, silver and copper. However, zinc and nickel also have a corresponding activity. The metal fractions may in this case be provided either in metallic form as particles incorporated into the fiber structure or as layers arranged on the fiber. It is likewise conceivable to provide the metal fractions in suitable ionic form, for example, as salts of said metals, in or on the fiber.

So that the throughput of process liquid is impeded only slightly, it is advantageous that the distance between adjacent spacer fiber elements of the fiber system is, on average, greater than 1 mm. Depending on the application field, the “free” path length between the spacer fiber elements may be made variable. Of course, the flow resistance depends on the flow velocity, so that, at very high flow velocities, spacings between spacer fiber elements of markedly more than one millimeter are required.

In terms of compressibility, the spacer fiber elements are preferably designed in such a way that the fiber system can be compressed by at least 20% of its transverse extent in a direction transverse to the first sheet-like structure. The amount of possible compression depends, on the one hand, on the restoring forces of the compressed spacer fiber elements. On the other hand, however, excessive compression may also be undesirable in light of the rising flow resistance of the compressed fiber system.

The sheet-like structures are designed, in a way known from the prior art, particularly as an interlacing, contexture, knitted fabric, woven fabric, knitted yarns or as fiber flock elements. Due to its structure, the sheet-like structure makes it possible to detect a surface, with respect to which spacer fiber elements extend transversely and thus, together with the sheet-like structure, form an elastically deformable three-dimensional spacer structure. That is not to say that the sheet-like structure has a purely two-dimensional design. This would even be untrue to reality, since a sheet-like textile structure, by virtue of its construction, must always have some extent transversely with respect to its area of extent.

An interlacing is understood to mean a sheet-like structure which takes shape due to the crossing of interlaced fiber systems running diagonally in opposite directions, the interlacing fibers crossing one another at an adjustable angle with respect to the cloth edge.

A contexture is understood to mean a sheet-like structure consisting of one or more stretched fiber systems, lying one above the other, of various orientation directions, with or without fixing of the crossing points.

A knitted fabric is a sheet-like structure, in which the stitches are formed individually and in succession from a horizontally presented fiber. In addition, further fiber systems may be incorporated in the warp and/or weft direction for reinforcement.

A woven fabric is a sheet-like structure which contains at least two fiber systems which, as a rule, cross one another at right angles, a fiber system running parallel to the edge.

Knitted yarns are a sheet-like structure which is formed from one or more fiber systems by the simultaneous formation of stitches in the longitudinal direction. In addition, further fiber systems may be incorporated in the warp and/or weft direction for reinforcement.

Fiber flock elements are understood to mean sheet-like structures in which a sheet-like substrate is charged electrostatically, in order to arrange on it and permanently fix to it fibers of a defined cut length uniformly or in an intended systematic or random grid structure.

The spacer fiber elements may be woven, knitted, adhesively bonded or stitched together with the sheet-like structures mentioned above. In this case, the spacer fiber elements may either be in the form of a separate fiber or be designed as a fiber which is also arranged in the sheet-like structure.

In a preferred embodiment of the fiber system, the fiber system has a second sheet-like structure oriented essentially parallel to the first sheet-like structure, the spacer fiber elements spacing the first and the second sheet-like structure apart from one another.

There are existing technologies for weaving and knitwear production whereby the overall spatial structure of a fiber system having two adjacent sheet-like structures can be produced efficiently in one work process, for example, as a spacer fabric or knitted spacer fabric. In this case, both a single fiber and a combination of different fibers may be employed. Within the scope of the invention, at least one fiber must have the required germicidal activity.

As stated above, the second sheet-like structure may likewise be designed, in particular, as an interlacing, contexture, knitted fabric, woven fabric, knitted yarns or a fiber flock element.

The coupling of the spacer fiber elements to the second sheet-like structure can be implemented correspondingly to the above-described coupling to the first sheet-like structure.

In a variant to the fiber system, the complete fiber system is produced from one and the same fiber. However, this presupposes that the single fiber has the necessary elasticity properties for spacing apart the two sheet-like structures and suitable germicidal activity.

It is likewise conceivable that the two sheet-like structures are produced from an identical first fiber and the spacer fiber elements from a second fiber. In this case, the first and/or the second fiber can be equipped with the germicidal activity.

It applies to all the variants of the fiber system described above that the at least one fiber or one of the fibers has a multifilament or monofilament textile metalized yarn.

Alternatively or additionally, it is possible that one fiber or one of the fibers is designed as a metallic fiber. Fine wires, preferably made from high-grade steel, are considered here as metallic fiber, i.e. a metallic fiber consists entirely of metal. It is likewise conceivable, however, to employ a glass, basalt or carbon fiber having suitable properties in terms of elasticity and/or germicidal activity.

Further features and advantages of the invention are explained in connection with the description of examples. However, the present invention is not limited to the below mentioned examples

### 1. Open Cooling Circuits in Power Stations and Air Conditioners

Especially, large-scale power stations for production of electric power and heat are often equipped with so-called open cooling circuits. The term open means that cooling water is emitted to the surrounding atmosphere. This leads to the characteristic white water vapor clouds above the large-scale cooling towers of these power stations. At the bottom of the cooling towers, the so-called cooling tower basin is formed as reservoir for the cooling water. The cooling water is pumped from the cooling tower basin by means of pump through a piping system into the condensing device of the power station. After having passed the condensing device, the cooling water is usually heated up to a temperature of from 30 to 40° C. This cooling water heated up is trickled into water droplets by a trickling equipment arranged at about one third of the cooling tower height in the cooling tower. The water droplets fall down in the direction of the cooling tower basin. In the air flow moving from below to top through the cooling tower, the trickled cooling water cools down. Then, the air flow carries along some percent of the cooling water in the form of water vapor, the evaporation enthalpy of the water further contributing to cooling down of the remaining cooling water in the liquid phase. The water vapor carried along condenses subsequent to the adequate cooling down in the atmosphere on top of the cooling tower into water droplets. Thereby, the characteristic view of the whitely steaming power station cooling tower originates.

The arising temperatures of the cooling water afford good living conditions for microorganisms. Because the system is open towards the atmosphere, material being suitable as aliment for microorganisms enters inevitably into the system. Due to these reasons, there is often a need to work regularly with biocides especially in open cooling circuits in power stations to keep the microbial burden under control.

In case of unfavourable weather situations, it can practically not be avoided in the surroundings of such cooling towers that cooling water droplets approach again in relatively high concentration to the ground so that they are inevitably inhaled by human. In this manner, there occurred already several times epidemic of legionella in the vicinity of large-scale power stations.

By the above described antimicrobial fiber system, the microbial burden of the cooling water, especially with legionella, can be ensured in a particular easy manner. For it, the fiber system is inserted into the region of the cooling tower basin and/or the piping system of the cooling water circuit. Due to the form being variably designable in broad ranges, elasticity and the fraction of antimicrobially equipped fiber material, it can be used in a best possible adjusted manner in all regions of the cooling water circuit.

Open cooling circuits being designed correspondingly smaller can be provided in air conditioners. Usually, they are arranged on roofs of buildings, from where microbially burdened cooling or condensed water can come to the atmosphere. Here, by the use of the antimicrobial fiber system, the microbial burden can also be avoided, reduced or eliminated, respectively, in an easy manner for a long time.

### 2. Cooling Lubricants in the Metal Working

As described in the introduction of the specification of this invention, process liquids in the form of cooling lubricants are very often used in metal working industrial or commercial plants. This can concern a CNC milling machine or a lathe, for example. Then, the cooling lubricant is directed by means of a supply device to the region of the workpiece to be processed which is just worked by the cutting, drilling or milling tool. Usually, the cooling lubricant flowing off is collected, separated from float off metal particles by a filter device and passed into a tank. From there, the cooling lubricant is again directed by means of a pump device in the direction of the workpiece to be worked. In principle, tanks and possible storing container are suitable to be equipped with the antimicrobial fiber system. Here, the time of stay of the cooling lubricant ensures an adequate assimilation of silver ions preserving adequately the cooling lubricant against microbial activity even without using biocides critical to one's health.

### 3. Paper Machine

In the paper production, a fiber suspension is initially drained and then directed through press rolls and dried. During the drainage, water accumulated with cellulose fibers which has to be drawn off arises. For controlling the water stream to be drawn off, hydraulically switchable valve devices are provided. A hydraulic switching circuit having water as hydraulic switching medium serves for switching. Certain amounts of cellulose material always come to this switching medium. Thereby, microbial growth is made more likely in the switching circuit. Due to the increasing microbial burden, it is regularly needed not only to replace the switching medium but also to disinfect the entire switching circuit. In first tests, the antimicrobial fiber system in a container of the switching circuit was permanently contacted with the switching medium. The installation of the fiber system resulted in a reduction of the microbial activity of the switching medium by a factor of 100 within two weeks during running operation even after the further use of a switching circuit which was not disinfected from the inside.

### 4. Washing Machine

In the area of private and commercial washing machines for textiles, one tries to reduce continually the water consumption. It is an already known plan to collect the rinsing water of the last rinsing step in a reservoir and do not feed it into the wastewater system. In the subsequent washing step, this remained rinsing water should be used for the first washing step of the dirty washing. Due to the stagnation of the collected rinsing water occasionally for days and the good conditions for microorganisms (temperatures in the range of room temperature or slightly higher and food supply in the form of natural fibers), a microbial burden of the water in the reservoir occurs here quickly. This microbial burden can be easily and effectively prevented or significantly reduced by the antimicrobial fiber system, respectively.

5. Medical Technology In the field of medical technical devices and apparatuses, process liquids are used for different purposes. Often, a substantial point is that a sterile water containing process liquid and the piping systems associated with it remain permanently sterile.

### 6. Swimming Pool, Whirlpool

In the private field, it is not required that the water quality of the process water in swimming pools or in whirlpools meets the legal requirements for drinking water. Often, drinking water which has however very quickly no drinking water quality due to the microbial growth occuring due to organic matter entered is filled therein. Often, disinfectants are used to fight to microbial growth or to keep it within limits. However, they are not always harmless to one's health or have undesired side effects, f.e., an offensive smell. Here, the fiber system can be used for the treatment of the process water to achieve the desired microbial effect. Preferably, a fiber system which is formed at least in portions from a fiber designed as twine is used, the twine having both a silver containing fiber and a copper containing fiber. The use of copper is motivated by its strongly algicidal microbial effect.

### 7. Ballast Water for Ships

Usually, seagoing ships which are empty or not completely loaded, take in ballast water in form of sea or ocean water to create a more stable position of the hull. Organisms are inevitably took in by this sea or ocean water in an ecosystem and carried off to another ecosystem. In the past, this has lead already to a series of high influences on regional ecosystems in oceans and rivers. The use of the fiber system for treating process water in the form of ballast water is an easy and low-cost measure to kill or significantly reduce the undesirable microorganisms, respectively.

1. A use of a three-dimensional fiber system produced by textile manufacturing having
at least one first sheet-like structure, wherein a plurality of spacer fiber elements extend transversely to the sheet-like structure in such a manner that the fiber system forms an elastically deformable three-dimensional spacer structure and a fiber having oligodynamic metal fractions is arranged in the sheet-like structure and/or in the region of the spacer fiber elements,
for anti-microbial treatment of a process liquid in a process liquid system.

2. The use according to claim 1, characterized in that the process liquid acts as cooling liquid.

3. The use according to claim 2, characterized in that the process liquid is provided as cooling liquid in a cooling system of an industrial or commercial plant, respectively.

4. The use according to claim 3, characterized in that the cooling system is designed in portions open to the surrounding atmosphere in such a manner that the surrounding atmosphere contacts the cooling liquid.

5. The use according to claim 4, characterized in that the fiber system is employed in a power station or in an air conditioner being provided with an open cooling water circuit in such a manner that cooling water is at least partially ejected into the atmosphere.

6. The use according to claim 4, characterized in that the fiber system is employed in the cooling system of an industrial or commercial plant (paper plant, textile machine, machine tools etc.).

7. The use according to claim 3, characterized in that the fiber system is employed in a power station, in an air conditioner or an industrial or commercial plant having a closed cooling water circuit.

8. The use according to claim 2, characterized in that the process liquid in the form of a cooling lubricating liquid acts additionally as lubricating liquid.

9. The use according to claim 8, characterized in that cooling lubricating liquid is employed as water-oil-emulsion in a cooling lubricating liquid system.

10. The use according to claim 1, characterized in that the process liquid is employed as hydraulic medium in a hydraulic switching or controlling circuit of an industrial or commercial plant.

11. The use according to claim 10, characterized in that the industrial plant is designed as paper producing and/or processing plant or as plant for producing and/or processing textiles.

12. The use according to claim 1, characterized in that the process liquid in a washing apparatus for laundry is treated as remained laundry rinsing water.

13. The use according to claim 12, characterized in that the laundry rinsing water will be employed as washing water for a newly starting washing step of the washing apparatus.

14. The use according to claim 1, characterized in that the process liquid is treated as water containing liquid in a medical technical device or for a medical technical device.

15. The use according to claim 1, characterized in that the process liquid is treated as filling water of a swimming pool or a whirlpool.

16. The use according to claim 1, characterized in that the process liquid is treated as ballast water in a ship.
